(19) United States
(12) Patent Application Publication
(10) Pub. No.: US 2017/0271931 A1
(43) Pub. Date: Sep. 21, 2017

(54) ROTOR, MOTOR, AIR-CONDITIONING APPARATUS, AND ROTOR MANUFACTURING METHOD

(71) Applicant: Mitsubishi Electric Corporation, Tokyo (JP)

(72) Inventors: Hironori YABUUCHI, Tokyo (JP); Junya TABIRA, Tokyo (JP)

(73) Assignee: Mitsubishi Electric Corporation, Tokyo (JP)

(21) Appl. No.: 15/528,594

(22) PCT Filed: Jan. 7, 2015
(86) PCT No.: PCT/JP2015/050272

§ 371 Date: May 22, 2017

(51) Int. Cl. H02K 1/27; F04D 19/00; H02K 15/12; H02K 3/34; B29C 45/14; H02K 1/18; F24F 1/02

(52) U.S. Cl. CPC H02K 1/27; H02K 1/18; F04D 19/002; F24F 1/02; H02K 3/34; B29C 45/14; H02K 15/12; H02K 1/22

(57) ABSTRACT

A rotor includes a shaft, an inner core into which the shaft is inserted, an outer core provided on an outer peripheral side of the inner core, the outer core including a plurality of split cores connected annularly, each of the split core including a plurality of thin plate materials stacked; and a connecting member in which the inner core and the outer core are molded with resin and fixed. The connecting member is configured such that one end face of the outer core having a level difference caused by stacking thickness deviation of each of the split cores is flattened with the resin.

### CROSS REFERENCE TO RELATED APPLICATION

This application is a U.S. national stage application of International Application No. PCT/JP2015/050272, filed on Jan. 7, 2015, the contents of which are incorporated herein by reference.

### TECHNICAL FIELD

The present invention relates to a rotor to be equipped in various types of electric devices or other devices, a motor, an air-conditioning apparatus, and a rotor manufacturing method.

### BACKGROUND

As a method of forming a rotor of a motor, a stacking method in which a rotor is formed by stacking thin plate materials (press materials) punched by press work has been known conventionally. The stacking method is widely adopted for a rotor of an SPM motor, an IPM motor, or an outer rotor, for example. In the metal constituting a rotor, an electromagnetic steel sheet, less affected by an iron loss, is used for a portion forming a magnetic force particularly (core back, in general). Even so, an eddy current loss due to a magnetic field, for example, is caused. Accordingly, it is difficult to form a rotor without performing stacking.

In the case of forming a rotor by the stacking method, a method of forming thin plate materials in a rotor shape by press work and stacking and fixing the formed thin plate materials, is used (Patent Literature 1, for example). Further, a method of forming thin plate materials in a split rotor shape and connecting the split cores, formed by stacking the thin plate materials, annularly, is also known (Patent Literature 2, for example).

Patent Literature 1 discloses a method in which to suppress deflection of the teeth formed in a stator core, a portion near the center of the teeth is supported by the support part provided in the mold, and resin is injected into the mold. Meanwhile, Patent Literature 2 discloses a forming method in which a rotor core formed of split cores, a frame, and a permanent magnet are integrated. Specifically, Patent Literature 2 adopts a method in which two pieces of permanent magnets stacked in a semi-cylindrical shape are inserted into respective holes formed in the rotor core, and with use of a shaping mold, resin is injected from a resin penetration hole formed in the frame.

### PATENT LITERATURE

Patent Literature 1: Japanese Unexamined Patent Application Publication No. 2000-125524

Patent Literature 2: Japanese Unexamined Patent Application Publication No. 2008-259359

However, in the case of forming a thin plate material in a stator shape by punching it from a rectangular slit material as in the case of Patent Literature 1, a large amount of end materials remain. This causes a problem that the yield is lowered and the cost is increased. Meanwhile, in the case of forming a rotor core by connecting split cores as in the case of Patent Literature 2, the stacking thickness of the split cores is not uniform due to thickness deviation of a thin plate material. This causes a problem that the surfaces of the split cores cannot be covered uniformly when they are integrally formed with the resin. Further, the motor of each of Patent Literatures 1 and 2 is not applied with an insulation process to prevent electrolytic corrosion of the rotor, causing a problem that reliability is not secured.

### SUMMARY

The present invention has been made to solve the above-described problems. An object of the present invention is to provide a rotor, a motor, an air-conditioning apparatus, and a rotor manufacturing method, having high productivity and reliability with a stable structure.

A rotor, according to an embodiment of the present invention, includes a shaft, an inner core into which the shaft is inserted, an outer core provided on an outer peripheral side of the inner core, the outer core including a plurality of split cores connected annularly, each of the split core including a plurality of thin plate materials stacked, and a connecting member in which the inner core and the outer core are molded with resin and fixed. The connecting member is configured such that one end face of the outer core having a level difference caused by stacking thickness deviation of each of the split cores is flattened with the resin.

Further, a rotor manufacturing method, according to an embodiment of the present invention, is a method of manufacturing a rotor including a shaft, an inner core into which the shaft is inserted, an outer core provided on an outer peripheral side of the inner core, the outer core including a plurality of split cores connected annularly, each of the split core including a plurality of thin plate materials stacked, and a connecting member in which the inner core and the outer core are molded with resin and fixed. The method includes, with use of a mold capable of following contraction of the resin, injecting the resin of an amount set in advance based on stacking thickness deviation of each of the split cores, and by the following of the mold, flattening one end face of the outer core having a level difference caused by the stacking thickness deviation of each of the split cores, with the resin.

In an embodiment of the present invention, a level difference caused in one end face of the outer core due to stacking thickness deviation of each of the split cores is covered with resin constituting the connecting member, and the one end face is flattened. Therefore, it is possible to stabilize the structure of the rotor and to improve productivity and reliability.

### BRIEF DESCRIPTION OF DRAWINGS

FIG. 1 is a schematic diagram illustrating a side face of a motor according to an embodiment of the present invention.

FIG. 2 is a perspective view illustrating a rotor constituting the motor of FIG. 1.

FIG. 3 is a schematic diagram illustrating a top face of the rotor of FIG. 2.

FIG. 4 is a schematic cross-sectional view taken along a line A-A of FIG. 3.

FIG. 5 is a schematic diagram illustrating a state where a magnet is attached to the periphery of the rotor body of FIG. 3.

FIG. 6 is a flowchart illustrating a method of manufacturing the rotor of FIG. 1.

FIG. 7 is an external view of an air-conditioning apparatus equipped with the motor of FIG. 1.

FIG. 8 is a side view illustrating a motor and a fan provided to the air-conditioning apparatus of FIG. 7.

FIG. 9 is a perspective view illustrating a rotor having a conventional configuration.

FIG. 10 is a schematic diagram illustrating a top face of the rotor of FIG. 9.

### DETAILED DESCRIPTION

### Embodiment

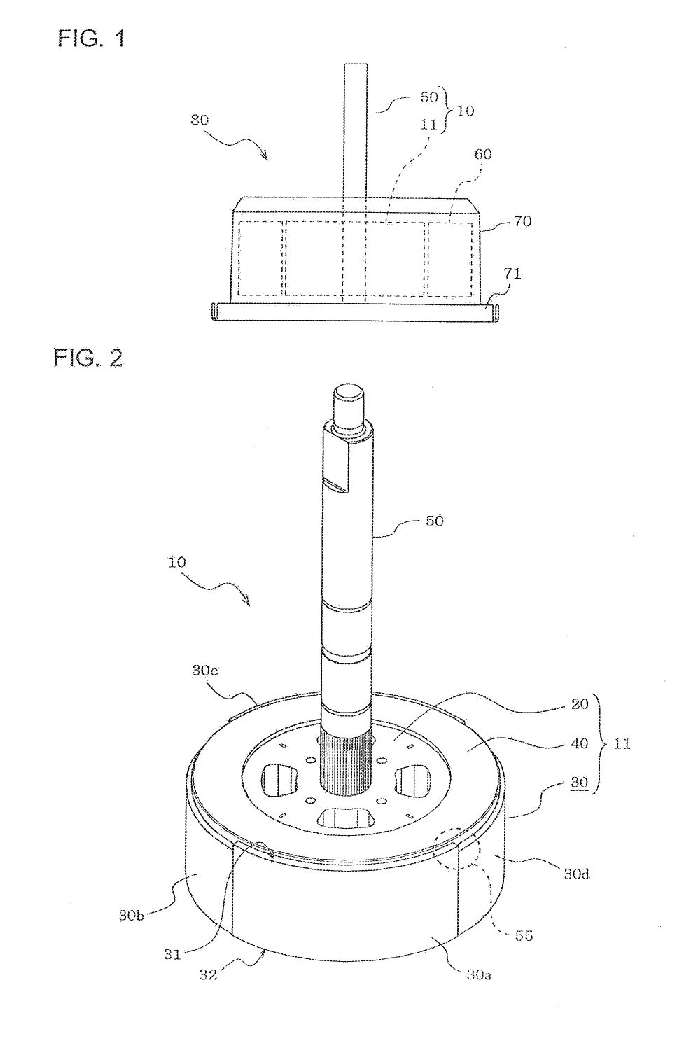

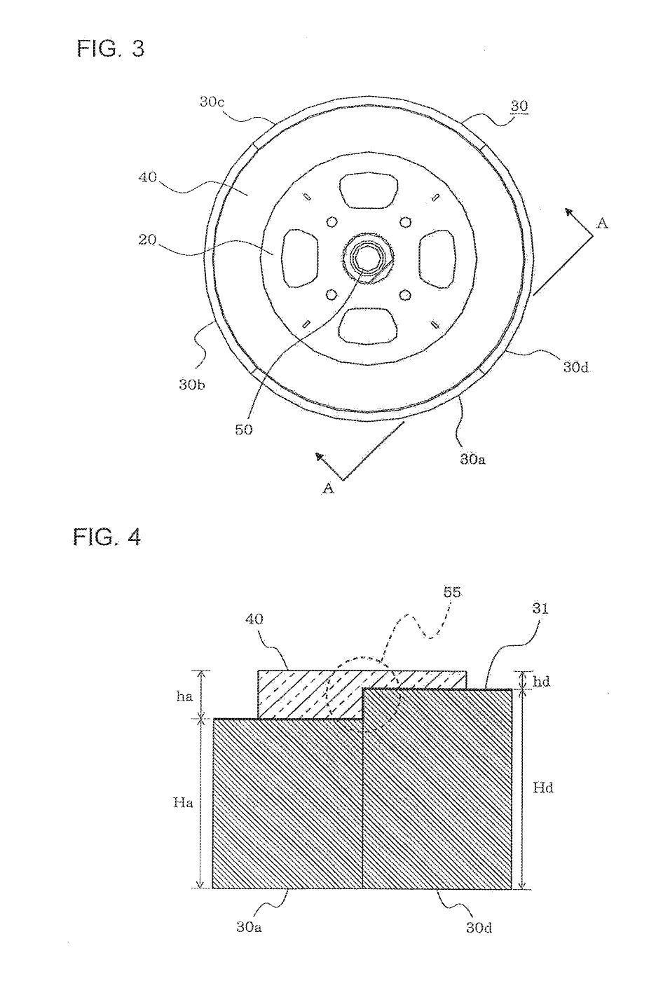

FIG. 1 is a schematic diagram illustrating a side face of a motor 80 according to an embodiment of the present invention. FIG. 2 is a perspective view illustrating a rotor 10 constituting the motor 80, and FIG. 3 is a schematic diagram illustrating a top face of the rotor 10. As illustrated in FIGS. 1 to 3, the motor 80 includes a stator 60 around which a coil (not shown) is wound, a rotor 10 rotatably disposed on the inner peripheral surface side of the stator 60, and a body shell 70 in which the stator 60 is molded with resin different from the resin constituting the connecting member 40 and fixed. The connecting member 40 will be de described in detail below. Although not shown, the stator 60 includes a stator pole piece formed by superposing a plurality of electromagnetic steel sheets, a winding thorough which electric current supplied from the power source flows, and an insulator provided to the stator pole piece and used for insulation of the coil.

The rotor 10 is configured such that a shaft 50 is connected to a rotor body 11 including the inner core (boss) 20 and the outer core (yoke) 30 forming a rotor core, and a connecting member 40 in which the inner core 20 and the outer core 30 are molded by resin and fixed. Further, the rotor 10 is provided with a bearing (not shown). The rotor 10 is arranged coaxially with the stator 60 in a cylindrical shape. The shaft 50 is inserted in the inner core 20.

The outer core 30 is configured such that a plurality of split cores 30a to 30d are connected annularly and provided on the outer peripheral side of the inner core 20. Each of the split cores 30a to 30d is formed by stacking a plurality of thin plate materials. More specifically, each of the split cores 30a to 30d is formed by piling up thin plate materials up to a required height and fixing them by caulking or the like. In the case of stacking thin plate materials up to the required height, as a thin plate material has thickness deviation, a level difference 55 is caused in one end face 31 of the outer core 30 when they are arranged to make the other end face 32 of the outer core 30 flat. This means that the outer core 30 has the level difference 55 in the one end face 31 caused by stacking thickness deviation of the split cores 30a to 30d.

FIG. 2 exemplary illustrates a case where the stacking thickness of the split cores 30a and 30c is relatively large and the stacking thickness of the split cores 30b and 30d is relatively small. Accordingly, the level difference 55 is caused in each portion where the split cores 30a and 30d are connected.

As the number of splits of the outer core 30 (the number of split cores) increases, the outer diameter of each split core is close to a straight line. Accordingly, when a thin plate material is punched from a rectangular slit material, the amount of end material is reduced, which improves the yield. However, this involves a disadvantage that fabrication such as stacking and connection takes time. Further, in the case of adopting a configuration of providing a split portion on the rear surface of a magnet, the split portion forms resistance of a magnetic flux (split portion has an air layer forming a flux barrier), leading to deterioration of efficiency. Therefore, it is better to determine the number of splits of the outer core 30 according to the number of poles of the motor such that the number of splits is four when the number of poles of the motor is four, the number of splits is six when the number of poles is six, and when the number of splits is n, the number of poles is n. This is because when the number of splits of the outer core 30 conforms to the number of poles of the motor, an effect of the magnetic flux can be suppressed.

The connecting member 40 has an insulation property. By covering the level difference 55 in the outer core 30 with resin, the one end face 31 is flattened. In the present embodiment, the amount of resin constituting the connecting member 40 is set in advance based on the stacking thickness deviation of each of the split cores 30a to 30d based on the thickness deviation of the thin plate materials. Further, for shaping the connecting member 40, a mold (not shown) having a following mechanism capable of following resin contraction is used. The resin of the preset amount, injected into a mold in which the inner core 20 and the outer core 30 are arranged, flows all over the surface of the one end face 31 of the outer core 30, and by the following to the resin of the mold, the one end face 31 having the level difference 55 caused by variations in the stacking thickness of the split cores 30a to 30d is flattened. Thereby, it is possible to avoid a situation where the resin flows to a side having a lower stacking thickness of the split cores 30a to 30d and does not flow to a higher side.

FIG. 4 is a schematic cross-sectional view taken along a line A-A of FIG. 3. As illustrated in FIG. 4, the level difference 55 caused between the split core 30a and the split core 30d is covered with the resin constituting the connecting member 40, and the one end face 31 is flattened, for example. Here, the sum of the stacking thickness of the outer core 30 and the thickness of the resin formed on the one end face 31 of the outer core 30 is the same in the respective split cores 30a to 30d. In the example of FIG. 4, the sum of a stacking thickness Ha of the split core 30a and a thickness ha of the resin on the split core 30a equals to the sum of a stacking thickness Hd of the split core 30d and a thickness hd of the resin on the split core 30d. It should be noted that a similar state is found in adjacent split cores 30a to 30d.

As described above, in the present embodiment, it is possible to form the connecting member 40 by using resin of a preset amount, regardless of variations in the stacking thickness of the split cores 30a to 30d. This means that the rotor 10 can be formed without regard to the stacking thickness deviation of the split cores 30a to 30d. Accordingly, it is possible to stabilize the structure of the rotor 10 and to improve the yield and reliability. Consequently, the lifetime of the rotor 10 and the motor 80 can be elongated.

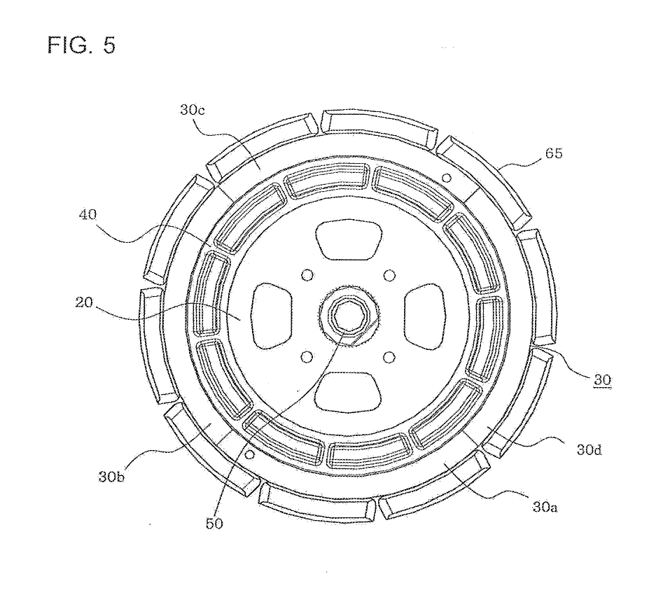

Meanwhile, the rotor 10 rotates when a magnetic field formed by energizing the coil wound around the stator 60 and a magnet installed on the surface or the inside of the rotor 10 repel each other. Here, FIG. 5 is a schematic diagram illustrating a state where a magnet 65 is attached around the rotor 10 of FIG. 3. The rotor 10 to which the magnet 65 is attached is used as a rotor of an SPM motor, for example.

Generally, as resin used for molding a rotor, thermoplastic resin is used. In the case of applying the rotor 10 to an SPM motor or the like to which a magnet is attached as described above, it is preferable to adopt, for the connecting member 40, resin having contractility of a level not providing a hindrance when a magnet is attached, such as PBT resin, for example. Further, in the case of placing an emphasis on the strength, inexpensive resin such as PP (poly propylene) may be adopted for the connecting member 40. Further, in the case of applying the rotor 10 to an IPM motor or the like (in the case where a magnet is not provided on the surface of the rotor 10), resin having a low contraction rate (e.g., thermosetting resin) may be used.

In the present embodiment, resin constituting the connecting member 40 is selected as appropriate according to the type of a motor to which the rotor 10 is applied. For example, in the case of applying the rotor 10 to an SPM motor, resin having preferable contractility is used. Accordingly, in the mold, even when resin flows all over the surface of the one end face 31 of the outer core 30, the side face of the rotor body 11 to which a magnet is attached is not affected due to contraction of the resin.

### (Rotor Manufacturing Method)

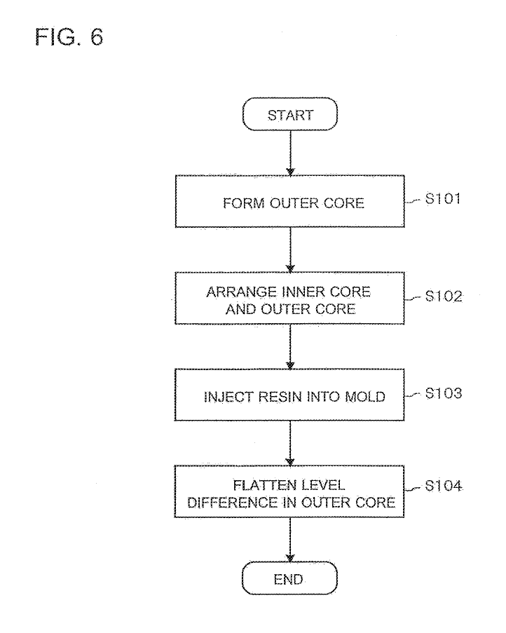

FIG. 6 is a flowchart showing a method of manufacturing the rotor 10. The connecting member 40 is formed using a mold (not shown) including a first mold and a second mold and having a following mechanism capable of following contraction of the resin, for example. As such, a method of manufacturing the rotor 10 will be described based on FIG. 6, on the assumption that the first mold is a movable side and the second mold is a fixed side.

First, a plurality of thin plate materials are stacked and fixed, and the split cores 30a to 30d are formed. Then, the respective split cores 30a to 30d are connected to form the outer core 30 (FIG. 6: step S101). Then, the inner core 20 and the outer core 30 are arranged in the first mold (FIG. 6: step S102). Here, in the first mold, a surface on which the other end face 32 of the outer core 30 abuts (hereinafter referred to as a “reference surface”) is flat. As the respective split cores 30a to 30d are arranged on the reference surface, end faces of the respective split cores 30a to 30d forming the other end face 32 are arranged on the same plane (made flush).

Next, the first mold and the second mold are put together, and resin of an amount preset based on the stacking thickness deviation of each of the split cores 30a to 30d is injected into the cavity of the mold (FIG. 6: step S103). Then, by the following of the mold, the other end face 31 of the outer core 30 having a level difference caused by the stacking thickness deviation of the split cores 30a to 30d is flattened with the resin. This means that the one end face 31 in which the level difference 55 is caused is flattened by allowing the following mechanism of the mold to follow the curing contraction of the resin flowing all over the surface of the one end face 31 of the outer core 30 (FIG. 6: step S104).

According to the rotor 10 manufactured through the respective steps described above, yield can be improved by adopting the split cores 30a to 30d, and the surface of the outer core 30 can be molded with resin reliably. As such, it is possible to stabilize the structure and to suppress electrolytic corrosion of the components such as a bearing. Therefore, according to the rotor 10 and the motor 80 equipped with the rotor 10 of the present embodiment, it is possible to improve the productivity and the reliability and to realize elongated lifetime.

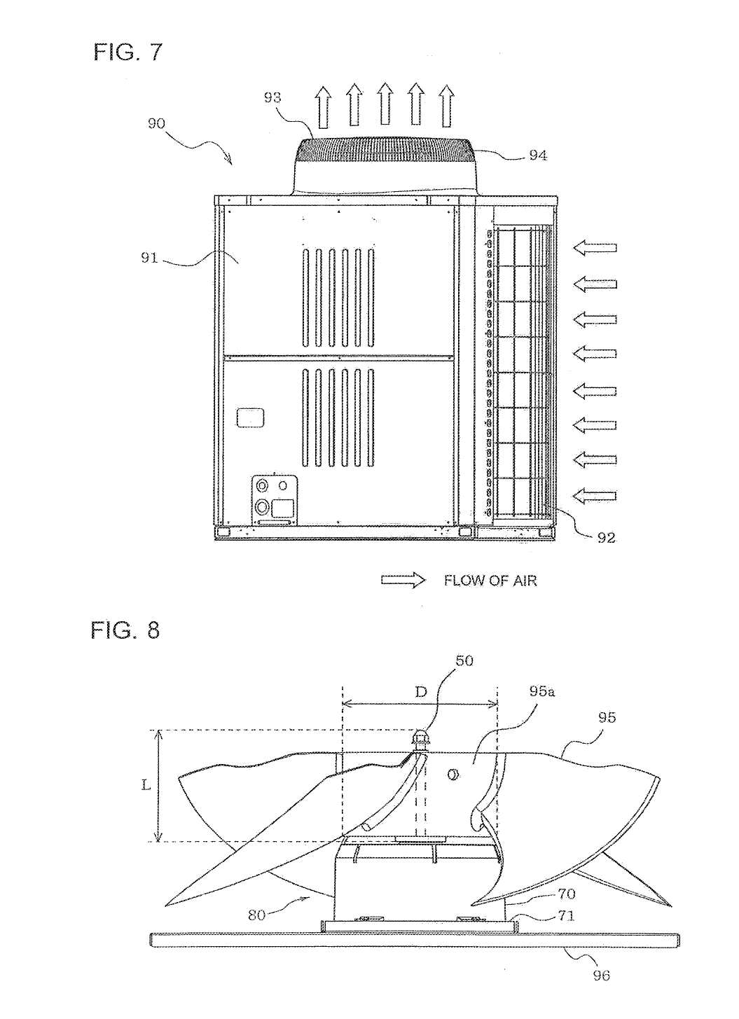

Next, an air-conditioning apparatus 90 equipped with the motor 80 of the present embodiment and a fixed state of the motor 80 will be described. FIG. 7 is an external view of the air-conditioning apparatus 90 equipped with the motor 80 of the present embodiment. The air-conditioning apparatus 90 is configured of an outdoor unit, for example, and is equipped with the motor 80. Accordingly, reliability as an apparatus is improved as the lifetime of the motor 80 is elongated.

As illustrated in FIG. 7, the air-conditioning apparatus 90 includes a casing 91 formed in a box shape, an air inlet 92 formed of an opening in a side face of the casing 91, a heat exchanger (not shown) arranged in the casing 91 along the air inlet 92, an air outlet 93 formed of an opening in the top face of the casing 91, and a fan guard 94 provided to cover the air outlet 93 in a manner enabling ventilation. Inside the fan guard 94, a fan 95 (see FIG. 8) driven by the motor 80 is provided. In the air-conditioning apparatus 90 configured as described above, when the fan 95 rotates, the air is sucked from the air inlet 92 in the side face of the casing 91, and after passing through the heat exchanger, the air flows vertically and is blown out upward from the air outlet 93 formed in the upper portion of the casing 91 (see void arrows in FIG. 7).

FIG. 8 is a side view illustrating the motor 80 and the fan 95 installed in the air-conditioning apparatus 90. Based on FIG. 8, an installation state of the motor 80 will be described. As illustrated in FIG. 8, the motor 80 is provided to a support member 96 with use of a leg portion 71. Moreover, the fan 95 is attached to the shaft 50 of the motor 80.

In FIG. 8, the support member 96 is configured of two rails, for example, and the motor 80 is mounted such that the bottom face side is brought into contact with the support member 96 and the shaft 50 faces upward. The fan 95 is attached to the shaft 50 of the motor 80, and the fan 95 is driven when the rotor 10 of the motor 80 rotates.

Here, the length of the shaft 50 is set such that a predetermined space is formed between the lower end of a blade of the fan 95 and the support member 96. In the present embodiment, the motor 80 is mounted on the support member 96 and fixed. As such, compared with the case of supporting the center portion of the motor 80, the length L of the shaft 50 can be shortened. Accordingly, axial runout of the fan 95 can be reduced. Further, reliability of the air-conditioning apparatus 90 of the present embodiment can be improved along with the elongated lifetime of the installed motor 80. It should be noted that the motor 80 may be formed such that the diameter in a planar view (diameter of the body shell 70) is smaller than the diameter D of the fan boss 95a of the fan 95. By adopting such a configuration, it is possible to reduce the resistance of the wind flowing from the lower side to the upper side of the motor 80.

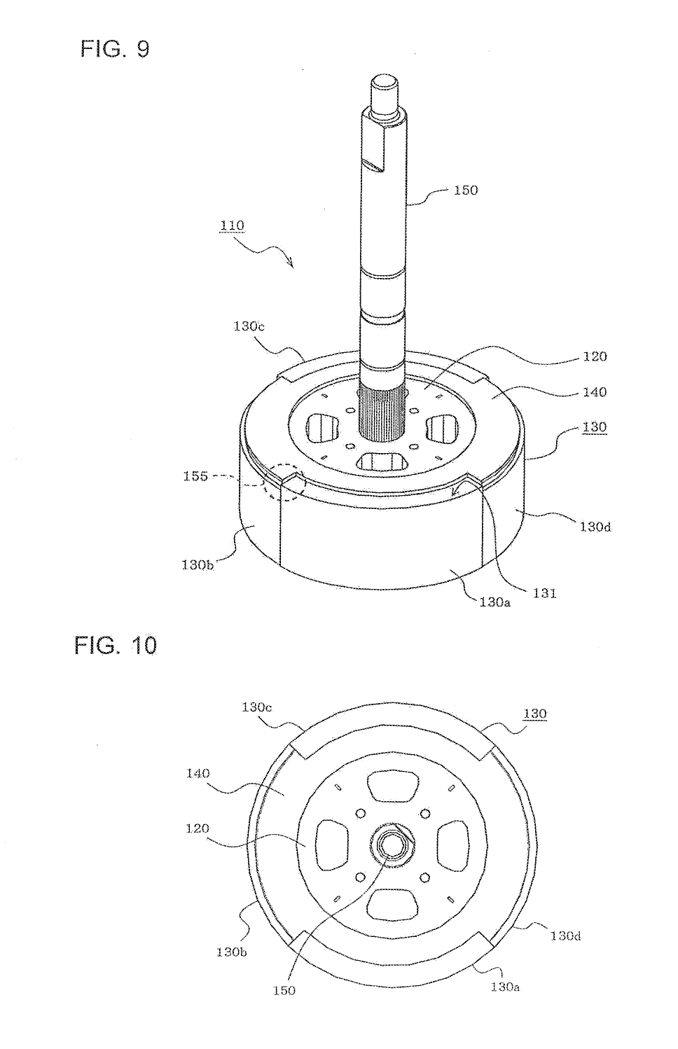

Here, a comparative example for explaining effects achieved by the rotor 10 in more detail will be described with reference to FIGS. 9 and 10. FIG. 9 is a perspective view illustrating a rotor 110 according to a conventional configuration. FIG. 10 is a schematic diagram illustrating the upper face of the rotor 110.

The rotor 110 includes an inner core 120, an outer core 130, a connecting member 140 in which the inner core 120 and the outer core 130 are molded with resin and fixed, and a shaft 150. The outer core 130 is formed such that a plurality of split cores 130a to 130d are connected annularly. Each of the split cores 130a to 130d is formed of a plurality of thin plate materials stacked.

The connecting member 140 is formed by a mold not having a following mechanism, and when setting the amount of resin to be injected into the mold, stacking thickness deviation of each of split cores 130a to 130d is not considered. Accordingly, when resin is injected in a state where the inner core 120 and the outer core 130 are arranged in the mold, the resin flows to the side of the split cores 130a to 130d where the stacking thickness is lower and does not flow to the side where the stacking thickness is higher.

FIG. 9 exemplary illustrates a case where the stacking thickness of the split cores 130a and 130c is relatively large and the stacking thickness of the split cores 130b and 130d is relatively small. A level difference 155 is caused in a portion where the respective split cores 130a to 130d are connected. This is in a state where resin is likely to flow to the side of the split cores 130b and 130d, and is less likely to flow to the side of the split cores 130a and 130d. Therefore, the resin injected into the mold flows to the side of the split cores 130b and 130d, and does not flow to the side of the split core 130a and 130d. Consequently, on the upper end face 131 of the outer core 130, the resin is cured in an uneven state. Referring to FIG. 10, it is found that the connecting member 140 made of resin is not formed on the upper end face 131 of the outer core 130 where the split cores 130a and 130d locate.

It should be noted that FIG. 9 illustrates an example in which a level difference is caused between the surface of the connecting member 140 and the upper end face 131 for the sake of convenience to clearly distinguish the connecting member 140 from the upper end face 131 of the respective split cores 130a to 130d. However, the relational configuration between the surface of the connection member 140 and the upper end face 131 is not limited to such a state. This means that in the rotor 110 having a conventional configuration, the surface of the connecting member 140 may be lower than the upper end face 131 or the surface of the connecting member 140 and the upper end face 131 may be made flush.

As described above, the rotor 110 of a conventional configuration has an unbalanced structure. Further, the outer core 130 cannot be covered sufficiently with the connecting member 140. Accordingly, electrolytic corrosion of the bearing or the like cannot be prevented effectively, leading to low reliability.

On the other hand, the rotor 10 of the present embodiment includes the shaft 50, the inner core 20 into which the shaft 50 is inserted, the outer core 30 formed of a plurality of split cores 30a to 30d in each of which a plurality of thin plate materials are stacked are connected annularly and provided on the outer peripheral side of the inner core 20, and the connecting member 40 in which the inner core 20 and the outer core 30 are molded with resin. Further, in the connecting member 40, the one end face 31 of the outer core 30, having a level difference caused by stacking thickness deviation of the respective split cores 30a to 30d, is flattened with resin. Accordingly, it is possible to provide the rotor 10 having a stable structure and high reliability. Further, in the rotor 10, the amount of resin constituting the connecting member 40 having an insulation property is set based on the stacking thickness deviation of the respective split cores 30a to 30d, and the other end face 31 having the level difference 55 is flattened by integral formation with the resin using a mold having a following mechanism. Therefore, it is possible to stabilize the structure of the rotor 10, and to improve productivity and reliability.

It should be noted that the respective embodiments described above are preferred specific examples of a rotor, a motor, an air-conditioning apparatus, and a motor manufacturing method. While various types of technically preferable limitations may be included, the technical scope of the present invention is not limited to these aspects unless there is any description to limit the present invention particularly. For example, while the outer core 30 is configured of four split cores 30a to 30d in the embodiment described above, it is only necessary that the outer core 30 is formed at least in an annular shape. This means that the outer core 30 may be configured of any number of split cores in the same shape connected with each other, or configured of split cores of different shapes in which only a portion thereof is separated that are connected annularly.

1. A rotor comprising:
a shaft;
an inner core through which the shaft is inserted;
an outer core provided on an outer peripheral side of the inner core, the outer core including a plurality of split cores connected annularly, each of the split cores including a plurality of thin plate materials stacked; and
a connecting member made of resin and configured to cover and fix the inner core and the outer core,
the connecting member being configured to flatten one end face of the outer core having a level difference caused by stacking thickness deviation of each of the split cores is flattened with the resin.

2. The rotor of claim 1, wherein
an amount of the resin constituting the connecting member is determined based on the stacking thickness deviation of each of the split cores based on a thickness deviation of the thin plate materials.

3. The rotor of claim 1, wherein
a sum of stacking thickness of the outer core and thickness of the resin formed on an other end face of the outer core is a same in each of the split cores.

4. The rotor of claim 1, wherein
the resin is thermoplastic resin or thermosetting resin.

5. A motor comprising:
a stator around which a coil is wound;
the rotor of claim 1 arranged rotatably on an inner peripheral surface side of the stator; and
a body shell made with resin different from the resin constituting the connecting member, and
configured to cover the stator.

6. An air-conditioning apparatus comprising:
a fan arranged in a casing, the fan being configured to suck air from an air inlet and blow out the air passing through a heat exchanger from an air outlet;
a fan motor configured to drive the fan; and
a support member to which the fan motor is fixed via a fixing member, wherein as the fan motor, the motor of claim 5 is adopted.

7. A method of manufacturing a rotor, the rotor including an inner core through which the shaft is inserted, an outer core including a plurality of split cores connected annularly, the split core including a plurality of thin plate materials stacked, and a connecting member in which the inner core and the outer core are molded with resin and fixed, the method comprising:
arranging the inner core in a first mold, and arranging the outer core on an outer peripheral side of the inner core with a first end face of the outer core being abutted on a flat reference surface of the first mold,
engaging the first mold and a second mold with each other, and injecting the resin of an amount based on stacking thickness deviation of each of the split cores based on a thickness deviation of the thin plate materials, into a cavity formed by the first mold and the second mold, and
allowing following mechanisms of the first mold and the second mold to follow a curing contraction of the resin, flattening a second end face of the outer core with the resin thereby forming the connecting member.

8. The rotor of claim 1, wherein,
on an other end face of the outer core, end faces of the respective split cores are arranged on a same plane.
